(19) United States
(12) Patent Application Publication
(10) Pub. No.: US 2013/0182370 A1
(43) Pub. Date: Jul. 18, 2013

(54) CAPACITOR

(71) Applicant: SANYO Electric Co., Ltd., Osaka (JP)

(72) Inventors: Miwa Ogawa, Hirakata-shi (JP); Gaku Harada, Kawanishi-shi (JP); Kaori Ishikawa, Nishinomiya-shi (JP); Hitoshi Hirano, Nishinomiya-shi (JP)

(73) Assignee: SANYO Electric Co., Ltd., Osaka (JP)

(21) Appl. No.: 13/622,050

(22) Filed: Sep. 18, 2012

(30) Foreign Application Priority Data
Sep. 28, 2011 (JP) 2011-212705

(51) Int. Cl. H01G 2/14

(52) U.S. Cl. CPC H01G 2/14
USPC 361/301.4

(57) ABSTRACT

A capacitor includes an anode made of metal, a first dielectric layer formed on a surface of the anode, a cathode made of metal, and a second dielectric layer formed on a surface of the cathode. The first dielectric layer contains an oxide of the metal forming the anode. The second dielectric layer contains an oxide of the metal forming the cathode. The anode and the cathode are stacked such that the first and second dielectric layers face each other.

### INCORPORATION BY REFERENCE

Japanese patent application Number 2011-212705, upon which this patent application is based, is hereby incorporated by reference.

### BACKGROUND OF THE INVENTION

1. Field of the Invention

The invention relates to a capacitor with an anode and a cathode stacked with an insulator placed therebetween.

2. Description of Related Art

A capacitor conventionally suggested as a capacitor of this type includes a tantalum foil to become an anode, an oxide film (dielectric layer) formed on a surface of the tantalum foil by chemical conversion, and a metal film to become a cathode. The metal film is formed on a surface of the oxide film.

In the conventional capacitor, however, if a defect such as a crack is generated in the oxide film, dielectric breakdown is generated through the defect. This leads to reduction of a withstand voltage.

### SUMMARY OF THE INVENTION

A capacitor of the invention includes an anode made of metal, a first dielectric layer formed on a surface of the anode, a cathode made of metal, and a second dielectric layer formed on a surface of the cathode. The first dielectric layer contains an oxide of the metal forming the anode. The second dielectric layer contains an oxide of the metal forming the cathode. The anode and the cathode are stacked such that the first and second dielectric layers face each other.

### BRIEF DESCRIPTION OF THE DRAWINGS

FIG. 1 is a sectional view schematically showing a stacked capacitor of a first embodiment of the invention;

FIG. 2 is a perspective view schematically showing the capacitor of the first embodiment;

FIG. 3 is a sectional view for explanation of the reason why the withstand voltage of the capacitor of the first embodiment is increased;

FIG. 4 is a sectional view schematically showing a stacked capacitor of a second embodiment of the invention;

FIG. 5 is a sectional view schematically showing a wound capacitor of a third embodiment of the invention;

FIG. 6 is a perspective view schematically showing the capacitor of the third embodiment;

FIGS. 7A to 7C are perspective views for explanation of steps of manufacturing the capacitor of the third embodiment;

FIGS. 8A and 8B are perspective views for explanation of steps of manufacturing the capacitor of the third embodiment;

FIG. 9 is a sectional view showing a capacitor of Example 1;

FIG. 10 is a sectional view showing a capacitor of Comparative Example 1;

FIG. 11 is a sectional view showing a capacitor of Example 2;

FIG. 12 is a sectional view showing a capacitor of Example 3;

FIG. 13 is a sectional view showing a capacitor of Comparative Example 2; and

FIG. 14 shows changes of currents with time flowing between electrodes of the capacitor of Example 1 and between electrodes of the capacitor of Example 2.

### DETAILED DESCRIPTION OF THE EMBODIMENTS

Embodiments of the invention are described in detail below by referring to the drawings. The invention is not intended to be limited to the embodiments described below.

### First Embodiment

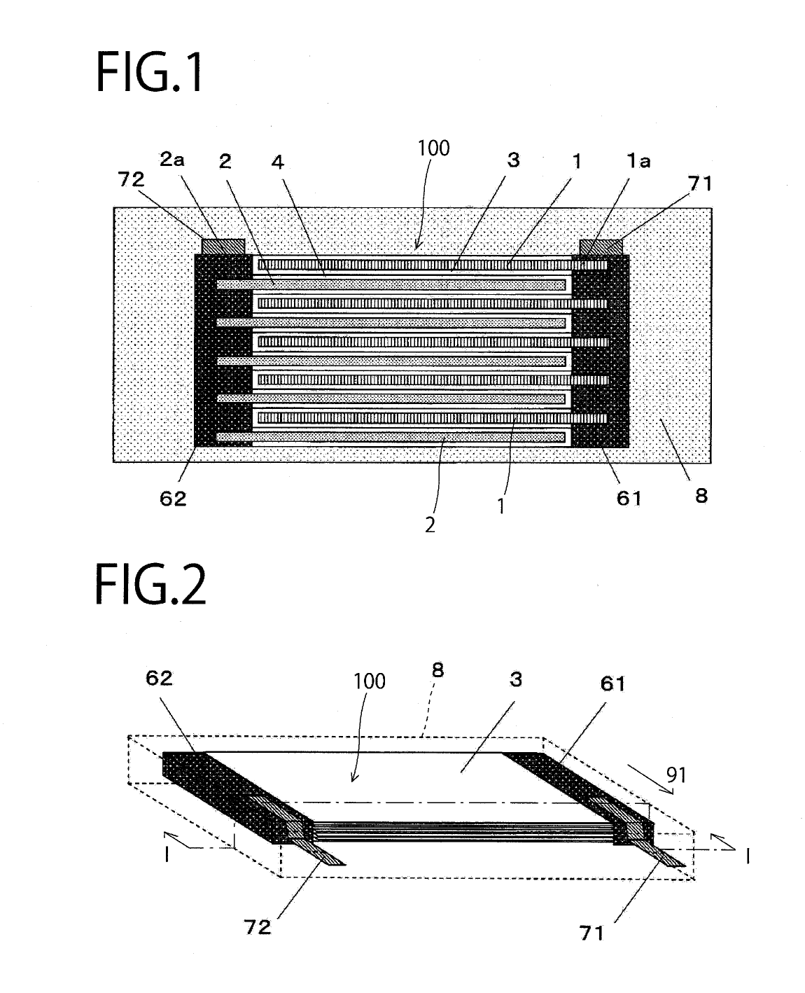

FIG. 1 is a sectional view schematically showing a stacked capacitor of a first embodiment of the invention. FIG. 2 is a perspective view schematically showing the capacitor of the first embodiment. FIG. 1 is a sectional view taken along line I-I of FIG. 2. As shown in FIGS. 1 and 2, the capacitor of the first embodiment includes a capacitor element 100, and an outer package 8 covering the capacitor element 100. In FIG. 2, the outer package 8 is indicated by dashed lines.

As shown in FIG. 1, the capacitor element 100 includes a plurality of anodes 1 each composed of a rectangular metal foil, and a plurality of cathodes 2 each composed of a rectangular metal foil. The anodes 1 and the cathodes 2 are stacked so as to overlap each other alternately one by one.

It is preferable that a valve acting metal or an alloy containing a valve acting metal be used as a metallic material of the anodes 1 and the cathodes 2. Use of such a metallic material makes it possible to form oxide films easily on surfaces of the anodes 1 and the cathodes 2 by process such as chemical conversion. Examples of the valve acting metal include aluminum, tantalum, niobium, titanium, hafnium, and zirconium. Examples of the alloy include an alloy of valve acting metals, and an alloy of a valve acting metal and a metal other than a valve acting metal. Of these materials listed here, it is particularly preferable that tantalum, niobium, aluminum, and titanium be employed as the metallic material of the anodes 1 and the cathodes 2, because oxides of these materials are relatively stable even at a high temperature.

Additionally, the anodes 1 and the cathodes 2 each may be composed of: a metal foil made of a material of high conductivity such as copper, gold, and silver; and a layer of a valve acting metal formed on a surface of the metal foil. In this case, oxide films can be formed easily on surfaces of the anodes 1 and the cathodes 2 while the conductivities of the anodes 1 and the cathodes 2 are enhanced.

A first dielectric layer 3 is formed on each of the anodes 1. Except a surface of an edge portion la of the anode 1, the first dielectric layer 3 covers the entire surface of the anode 1 (upper and lower surfaces, opposite side surfaces, and an end surface of an edge portion opposite to the edge portion 1a). Further, a second dielectric layer 4 is formed on each of the cathodes 2. Except a surface of an edge portion 2a of the cathode 2, the second dielectric layer 4 covers the entire surface of the cathode 2 (upper and lower surfaces, opposite side surfaces, and an end surface of an edge portion opposite to the edge portion 2a).

The first dielectric layer 3 is composed of an oxide of the metal forming the anode 1. Further, the second dielectric layer 4 is composed of an oxide of the metal forming the cathode 2. So, the first and second dielectric layers 3 and 4 each is an oxide film such as aluminum oxide, tantalum oxide, niobium oxide, and titanium oxide. The oxides to form the first and second dielectric layers 3 and 4 may be an oxide having a high dielectric constant, and examples of this oxide include SrTiO₃, CaTiO₃, MgTiO₃, BaTiO₃, (Ba,Sr)TiO₃, PbTiO₃, Pb(Zr,Ti)O₃, (Pb,La)(Zr,Ti)O₃, and Pb(Mg,Nb)O₃. These oxides can be obtained by chemical conversion of the anodes 1 and the cathodes 2 in a solution containing a metallic element.

The anodes 1 and adjacent ones of the cathodes 2 are stacked such that the first and second dielectric layers 3 and 4 face each other. In the first embodiment, there is no interposition between the first and second dielectric layers 3 and 4, so that the first and second dielectric layers 3 and 4 directly contact each other.

Further, the anodes 1 and the cathodes 2 are stacked such that their edge portions 1a and 2a respectively are pulled out toward opposite directions.

The first dielectric layers 3 are not formed on the surfaces of the edge portions 1a, and the edge portions 1a are electrically connected to each other through a connecting part 61.

As a result, all the anodes 1 are electrically connected to each other through the connecting part 61. Further, the second dielectric layers 4 are not formed on the surfaces of the edge portions 2a, and the edge portions 2a are electrically connected to each other through a connecting part 62. As a result, all the cathodes 2 are electrically connected to each other through the connecting part 62.

The connecting parts 61 and 62 can be formed by metallikon (metal spraying) in the manner described below. Molten metal such as zinc is sprayed on all the edge portions 1a to cover all the edge portions 1a with the metal and to place the metal between the edge portions 1a. Further, molten metal such as zinc is sprayed on all the edge portions 2a to cover all the edge portions 2a with the metal and to place the metal between the edge portions 2a.

Instead of formation of the connecting part 61, the edge portions 1a may be electrically connected to each other in the manner described below. First, the edge portions 1a are bent to contact each other directly. Then, contact surfaces between the edge portions 1a are welded. Further, instead of formation of the connecting part 62, the edge portions 2a may be electrically connected to each other in the manner described below. First, the edge portions 2a are bent to contact each other directly. Then, contact surfaces between the edge portions 2a are welded.

An extraction electrode 71 to extract a current to the outside is electrically connected to the upper surface of the connecting part 61. Further, an extraction electrode 72 to extract a current to the outside is electrically connected to the upper surface of the connecting part 62. As shown in FIG. 2, the extraction electrodes 71 and 72 are pulled out from the upper surfaces of the connecting parts 61 and 62 respectively to extend in the same direction 91 perpendicular to the longitudinal direction of the anodes 1 or the cathodes 2. The extraction electrode 71 is bent into a crank at the terminal edge of the connecting part 61 in the direction 91, and part of the extraction electrode 71 extends in a direction in which the anodes 1 and the cathodes 2 are stacked and along a side surface of the connecting part 61. Further, the extraction electrode 72 is bent into a crank at the terminal edge of the connecting part 62 in the direction 91, and part of the extraction electrode 72 extends in the direction in which the anodes 1 and the cathodes 2 are stacked and along a side surface of the connecting part 62.

The outer package 8 covers the anodes 1, the cathodes 2, and the first and second dielectric layers 3 and 4 entirely. Meanwhile, the outer package 8 covers the extraction electrode 71 partially to expose part of the extraction electrode 71 to the outside of the outer package 8. Further, the outer package 8 covers the extraction electrode 72 partially to expose part of the extraction electrode 72 to the outside of the outer package 8. A polymeric material having electrical insulating properties such as an epoxy resin is used to form the outer package 8.

A method of manufacturing the capacitor of the first embodiment is described next.

First, two or more anodes 1 are prepared. Each of the anodes 1 is in the form of a foil and is made of a valve acting metal. Then, each of the anodes 1 except the edge portion 1a thereof is dipped in an electrolyte solution, and a voltage is applied between the anode 1 and the electrolyte solution (chemical conversion). As a result, an oxide film of the metal forming the anode 1 is formed on the entire surface of part of the anode 1 dipped in the electrolyte solution, and the oxide film thereby formed becomes the first dielectric layer 3.

Likewise, two or more cathodes 2 are prepared. Each of the cathodes 2 is in the form of a foil and is made of a valve acting metal. Then, each of the cathodes 2 except the edge portion 2a thereof is dipped in an electrolyte solution, and a voltage is applied between the cathode 2 and the electrolyte solution (chemical conversion). As a result, an oxide film of the metal forming the cathode 2 is formed on the entire surface of part of the cathode 2 dipped in the electrolyte solution, and the oxide film thereby formed becomes the second dielectric layer 4.

Next, the anodes 1 and the cathodes 2 are made to overlap each other alternately one by one. At this time, regarding each of the anodes 1 and corresponding one of the cathodes 2 adjacent to each other, part of this anode 1 on which the first dielectric layer 3 is formed and part of this cathode 2 on which the second dielectric layer 4 is formed are made to overlap each other. In this way, the anodes 1 and the cathodes 2 are stacked such that the first and second dielectric layers 3 and 4 face each other. In the first embodiment, five anodes 1 and five cathodes 2 are prepared and stacked.

Additionally, during stacking of the anodes 1 and the cathodes 2, the anodes 1 and the cathodes 2 are arranged such that all the edge portions 1 a point in the same direction and are pulled out in this direction, and that all the edge portions 2a point in the same direction opposite the pointing direction of the edge portions 1a and are pulled out in the pointing direction of the edge portions 2a.

After the anodes 1 and the cathodes 2 are stacked, the edge portions 1a and the edge portions 2a are subjected to metallikon (metal spraying). More specifically, molten metal such as zinc is sprayed on all the edge portions 1a to cover all the edge portions 1a with the metal and to place the metal between the edge portions 1a. The connecting part 61 is formed in this way, so that the anodes 1 are electrically connected to each other. Further, molten metal such as zinc is sprayed on all the edge portions 2a to cover all the edge portions 2a with the metal and to place the metal between the edge portions 2a. The connecting part 62 is formed in this way, so that the cathodes 2 are electrically connected to each other.

Next, the extraction electrode 71 is fixed on the connecting part 61 with a conductive adhesive agent, so that the anodes 1 and the extraction electrode 71 are electrically connected to each other. Further, the extraction electrode 72 is fixed on the connecting part 62 with a conductive adhesive agent, so that the cathodes 2 and the extraction electrode 72 are electrically connected to each other. As a result, formation of the capacitor element 100 is completed.

Finally, the capacitor element 100 is covered with a molten epoxy resin and thereafter, the epoxy resin is cured, thereby forming the outer package 8. At this time, part of the extraction electrode 71 is exposed to the outside of the outer package 8, and part of the extraction electrode 72 is exposed to the outside of the outer package 8. Then, formation of the capacitor of the first embodiment is completed. The outer package 8 may also be formed by placing the capacitor element 100 between resin sheets, and thereafter, pressing the sheets against the capacitor element 100 by applying heat.

The capacitor of the first embodiment increases the withstand voltage thereof for the reason described below.

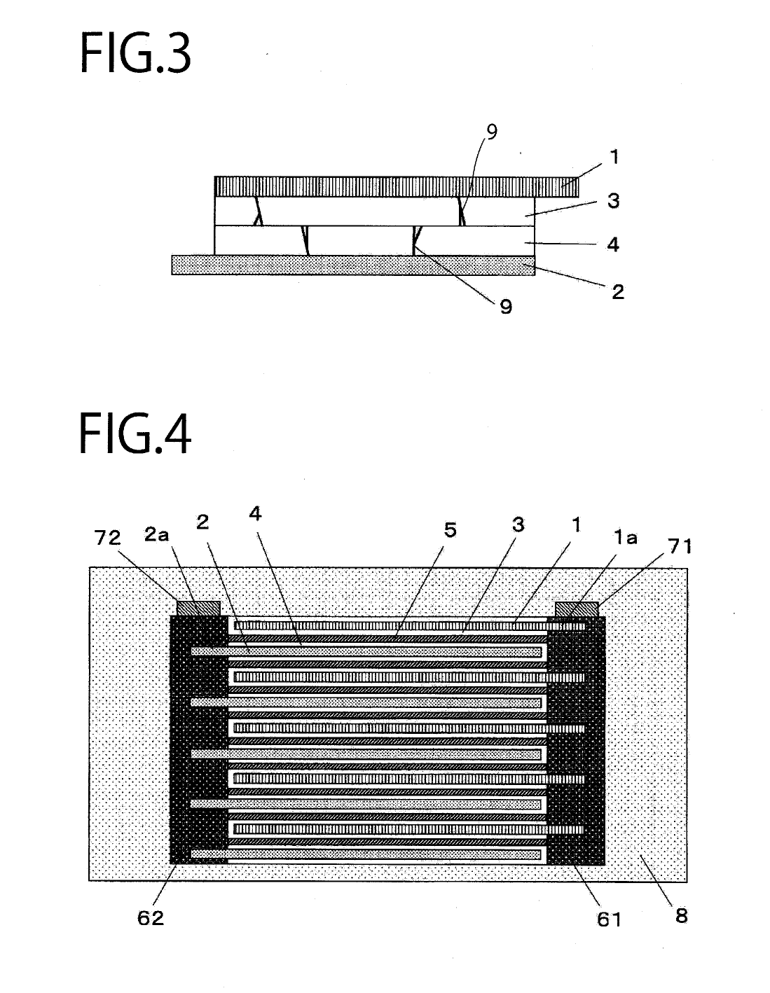

FIG. 3 is a sectional view for explanation of the reason why the withstand voltage of the capacitor of the first embodiment is increased. As shown in FIG. 3, the first and second dielectric layers 3 and 4 are placed between each of the anodes 1 and adjacent one of the cathodes 2. So, if cracks 9 are developed in the dielectric layers 3 and 4, the presence of the second dielectric layer 4 prevents the cracks 9 in the first dielectric layer 3 from reaching the cathode 2, and the presence of the first dielectric layer 3 prevents the cracks 9 in the second dielectric layer 4 from reaching the anode 1. Further, the cracks 9 in the first dielectric layer 3 and the cracks 9 in the second dielectric layer 4 are unlikely to link to each other. So, the cracks 9 are unlikely to link between the anode 1 and the cathode 2, in other words, unlikely to stretch from the anode 1 to the cathode 2. As a result, the anode 1 and the cathode 2 are unlikely to be electrically shorted to each other. In contrast, in the conventional capacitor including only the first or second dielectric layer 3 or 4, the cracks 9 are likely to stretch from the anode 1 to the cathode 2, so that the anode 1 and the cathode 2 are likely to be electrically shorted to each other. Thus, the capacitor of the first embodiment increases its withstand voltage compared to the conventional capacitor.

Additionally, in the capacitor of the first embodiment, a dielectric substance placed between the anode 1 and the cathode 2 is composed of two dielectric layers (first and second dielectric layers 3 and 4). So, the first and second dielectric layers 3 and 4 are each allowed to have a small thickness. If the anode 1 or the cathode 2 is chemically converted by applying a high voltage to the anode 1 or the cathode 2 in order to increase the thickness of a dielectric layer, the resultant dielectric layer becomes brittle. This leads to a high probability of generation of the cracks 9 in the dielectric layer. In contrast, if the anode 1 or the cathode 2 is chemically converted by applying a low voltage to the anode 1 or the cathode 2 to reduce the thickness of a dielectric layer, the cracks 9 are unlikely to be generated in the dielectric layer. Thus, in the capacitor of the first embodiment, the dielectric substance can be composed of a dielectric film having high resistance to the cracks 9. This suppresses electrical insulation breakdown through the cracks 9, so that the anode 1 and the cathode 2 are unlikely to be electrically shorted to each other.

In the first embodiment, the first and second dielectric layers 3 and 4 are formed by chemical conversion process on the anode 1 and the cathode 2 respectively. So, the first and second dielectric layers 3 and 4 are each allowed to have a uniform thickness easily. Thus, when a voltage is applied to the capacitor, the voltage is unlikely to concentrate in one position of the first or second dielectric layer 3 or 4. This increases resistance to insulation breakdown, so that the capacitor of the first embodiment is capable of achieving a higher withstand voltage.

### Second Embodiment

FIG. 4 is a sectional view schematically showing a stacked capacitor of a second embodiment of the invention. The capacitor of the second embodiment has the same structure as that of the capacitor of the first embodiment, except for that an adhesive layer 5 is placed between each of first dielectric layers 3 and facing one of second dielectric layers 4.

The adhesive layer 5 has electrical insulating properties. An organic material such as an organic insulator, an adhesive agent, an organic dielectric substance, and a thermally decomposable organic material, is applicable as a material of the adhesive layer 5.

Examples of the organic material include alkyl silicate based materials; rubber materials such as natural rubber, synthetic rubber and materials using the natural rubber and the synthetic rubber; silicone rubber; acrylic resins composed of alkyl acrylate ester homopolymers, alkyl acrylate ester copolymers, and copolymers of (meth)acrylic acid and different monomers (examples of the monomers include monomers containing a carboxyl group or an acid anhydride group, such as acrylic acids, methacrylic acids, itaconic acids, maleic acids, fumaric acids, and maleic anhydride; monomers containing a hydroxyl group; monomers containing a sulfonic acid group; monomers containing a phosphate group, monomers containing an amide group; monomers containing an amino group; monomers containing an alkoxy group; monomers containing an imide group; heterocyclic compounds containing a vinyl group; monomers containing a cyano group; acrylic monomers containing an epoxy group, and vinyl ether monomers); polyurethane resins; ethylene-vinyl acetate copolymers; fluorine resins; phenolic resins; epoxy resins; melamine resins; urea resins; polyester resins; alkyd resins; polyimide resins; polyethylene resins; polypropylene resins; polyvinyl chloride resins; polystyrene resins; polyvinyl acetate resins; acrylonitrile butadiene styrene resins; acrylonitrile styrene resins; polyamide resins; polyacetal resins; polycarbonate resins; polyphenylene ether resins; polybutylene terephthalate resins; polyethylene terephthalate resins; polyolefin resins; polyphenylene sulfide resins; polytetrafluoroethylene resins; polysulfone resins; polyether sulfone resins; polyallylate resins; liquid crystal polymers; polyether ether ketone resins; and polyamide-imide resins. The organic material may also be a gluing agent using the materials listed here, or an adhesive agent using monomers of the materials listed here, for example.

A method of manufacturing the capacitor of the second embodiment is described next.

The same process as that of the first embodiment is employed to form the first dielectric layer 3 on each of anodes 1 except an edge portion 1a thereof, and the second dielectric layer 4 on each of cathodes 2 except an edge portion 2a thereof.

Next, an adhesive agent to form the adhesive layer 5 is applied on the upper surfaces of the outer circumferences of the first dielectric layers 3 and the upper surfaces of the outer circumferences of the second dielectric layers 4. Examples of process for application of the adhesive agent include, but not specifically limited to, spin-coating process, dipping process, drop casting process, ink jet process, spraying process, screen printing process, gravure printing process, flexographic process, and vapor deposition process.

Then, the anodes 1 and the cathodes 2 are made to overlap each other alternately one by one. The positions of the anodes 1 and those of the cathodes 2 with respect to each other are the same as those described in the first embodiment. For placing one of the cathodes 2 over one of the anodes 1, the lower surface of the outer circumference of the second dielectric layer 4 is made to face the upper surface of the outer circumference of the first dielectric layer 3. Further, for placing one of the anodes 1 over one of the cathodes 2, the lower surface of the outer circumference of the first dielectric layer 3 is made to face the upper surface of the outer circumference of the second dielectric layer 4. As a result, the adhesive layer 5 is formed between the first and second dielectric layers 3 and 4. The adhesive agent may not be applied on the upper surface of the outer circumference of the first dielectric layer 3 formed on the anode 1 in the top layer.

Next, the same steps as those of the first embodiment are performed to complete the formation of the capacitor of the second embodiment.

In the capacitor of the second embodiment, the first and second dielectric layers 3 and 4 are made to adhesively contact each other through the adhesive layer 5. This realizes fixation of the anodes 1 and the cathodes 2 to each other to increase the mechanical strength of the capacitor. Further, provision of the adhesive layer 5 having electrical insulating properties between the first and second dielectric layers 3 and 4 achieves further increase of a withstand voltage.

Additionally, if a current intensively flows into a crack 9 in the first or second dielectric layers 3 or 4, heat generated near the crack 9 makes the adhesive layer 5 swell to increase a distance between one of the anodes 1 and adjacent one of the cathodes 2, or changes the properties of the adhesive layer 5 to enhance the electrical insulating properties of the adhesive layer 5. As a result, electrical isolation between the electrodes is recovered.

### Third Embodiment

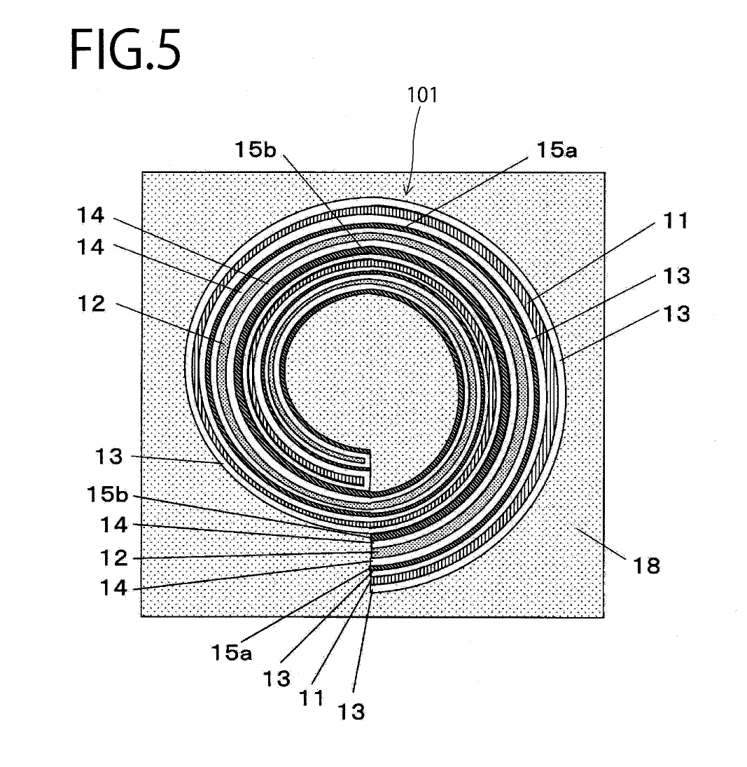

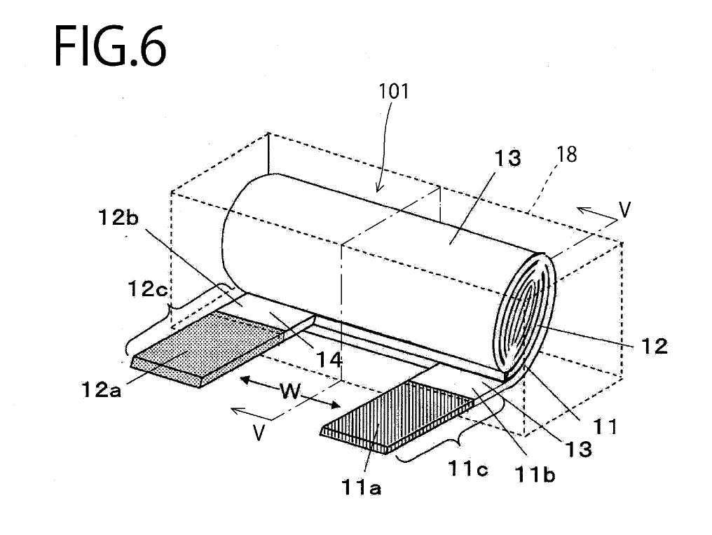

FIG. 5 is a sectional view schematically showing a wound capacitor of a third embodiment of the invention. FIG. 6 is a perspective view schematically showing the capacitor of the third embodiment. FIG. 5 is a sectional view taken along line V-V of FIG. 6.

As shown in FIGS. 5 and 6, the capacitor of the third embodiment includes a capacitor element 101, and an outer package 18 covering the capacitor element 101. In FIG. 6, the outer package 18 is indicated by dashed lines.

As shown in FIGS. 5 and 6, the capacitor element 101 includes an anode 11 composed of a metal foil of a long length, and a cathode 12 composed of a metal foil of a long length. The anode 11 and the cathode 12 are stacked while an adhesive layer 15a is placed therebetween, thereby forming a stacked structure. The stacked structure is wound into a spiral pattern to form a wound structure. Like in the first embodiment, it is preferable that a valve acting metal or an alloy containing a valve acting metal be used as a metallic material of the anode 11 and the cathode 12. Or, the anode 11 and the cathode 12 each may be composed of: a metal foil made of a material of high conductivity; and a layer of a valve acting metal formed on a surface of the metal foil.

A first dielectric layer 13 is formed on the surface of the anode 11 (upper and lower surfaces, opposite side surfaces, and an end surface of an edge portion close to the center of the spiral), except a surface of a front portion 11a of a narrow part 11c described later. Further, a second dielectric layer 14 is formed on the surface of the cathode 12 (upper and lower surfaces, opposite side surfaces, and an end surface of an edge portion close to the center of the spiral), except a surface of a front portion 12a of a narrow part 12c described later. Like in the first embodiment, the first dielectric layer 13 is composed of an oxide of the metal forming the anode 11, and the second dielectric layer 14 is composed of an oxide of the metal forming the cathode 12. Each of these oxides may contain a metallic element to increase the dielectric constant of the oxide.

In the aforementioned stacked structure, the anode 11 and the cathode 12 are stacked such that the first and second dielectric layers 13 and 14 face each other. The adhesive layer 15a has electrically insulating properties, and is placed between the first and second dielectric layers 13 and 14. Further, an adhesive layer 15b is formed in a surface region of the second dielectric layer 14, the surface region being opposite to a surface region thereof in which the adhesive layer 15a is formed. The stacked structure (including the anode 11 and the cathode 12) is wound into a spiral pattern while the adhesive layer 15b is placed at the inner side. So, in the wound structure, the adhesive layer 15b is placed between the outer circumference of the first dielectric layer 13 and the inner circumference of the second dielectric layer 14. The adhesive layer 15b also exists on the innermost part of the inner circumference of the second dielectric layer 14, the innermost part corresponding to the inner circumference of the wound structure. Meanwhile, the adhesive layer 15b does not exist on the outermost part of the outer circumference of the first dielectric layer 13, the outermost part corresponding to the outer circumference of the wound structure. Like in the second embodiment, each of the adhesive layers 15a and 15b may be made of an organic material.

As shown in FIG. 6, a cutout is provided at an edge portion of the anode 11 on a side opposite the center of the spiral. So, the anode 11 is provided with the narrow part 11c smaller in width than the other part of the anode 11. Additionally, the narrow part 11c is provided only on one side of a direction of the width of the anode 11. Further, a cutout is provided at an edge portion of the cathode 12 on a side opposite the center of the spiral. So, the cathode 12 is provided with the narrow part 12c smaller in width than the other part of the cathode 12. Additionally, the narrow part 12c is provided only on one side of a direction of the width of the cathode 12 opposite the side of the narrow part 11c. So, the narrow parts 11c and 12c are spaced apart from each other at an interval W, and are electrically isolated from each other.

The narrow parts 11c and 12c are pulled out in the same direction through the outer circumference of the wound structure. The narrow part 11c has the front portion 11a and a root portion 11b. Part of the first dielectric layer 13 is formed on a surface of the root portion 11b. Meanwhile, the first dielectric layer 13 is not formed on a surface of the front portion 11a, so that the metal forming the anode 11 is exposed at the surface of the front portion 11a. Further, the narrow part 12c has the front portion 12a and a root portion 12b. Part of the second dielectric layer 14 is formed on a surface of the root portion 12b. Meanwhile, the second dielectric layer 14 is not formed on a surface of the front portion 12a, so that the metal forming the cathode 12 is exposed at the surface of the front portion 12a.

The outer package 18 covers the anode 11, the cathode 12, and the first and second dielectric layers 13 and 14. A polymeric material having electrical insulating properties such as an epoxy resin is used to form the outer package 18. The front portions 11a and 12a of the narrow parts 11c and 12c respectively are not covered with the outer package 18 but they are pulled out of the outer package 18 to the outside. So, the front portions 11a and 12a form an anode extraction electrode and a cathode extraction electrode respectively. As shown in FIG. 5, part of the outer package 18 fills the inner side of the wound structure.

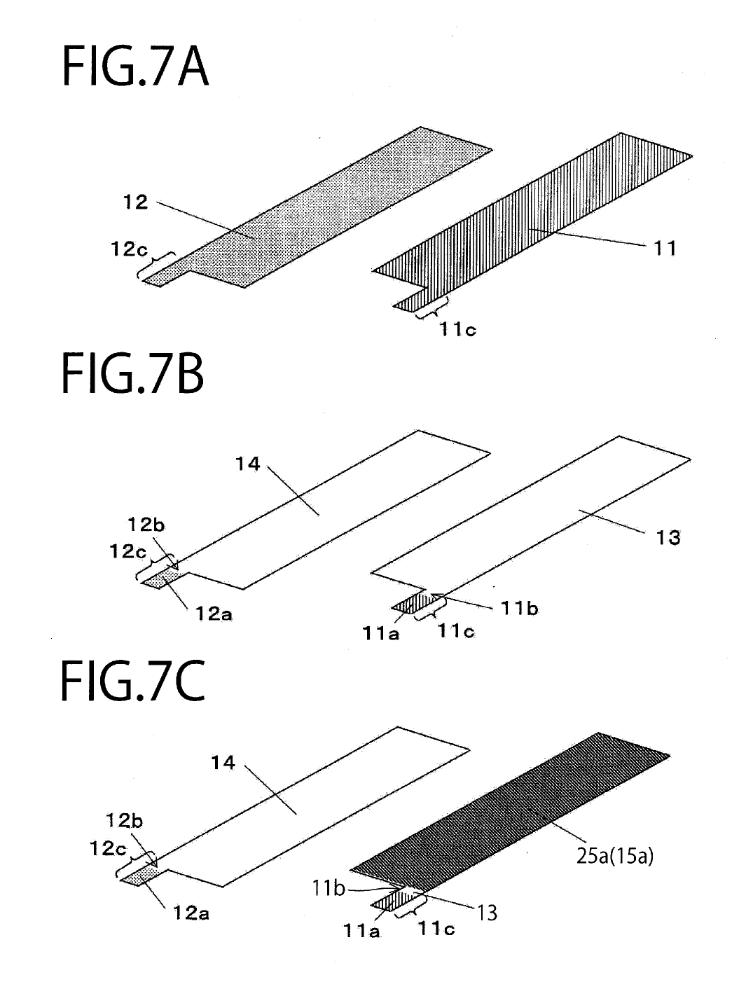

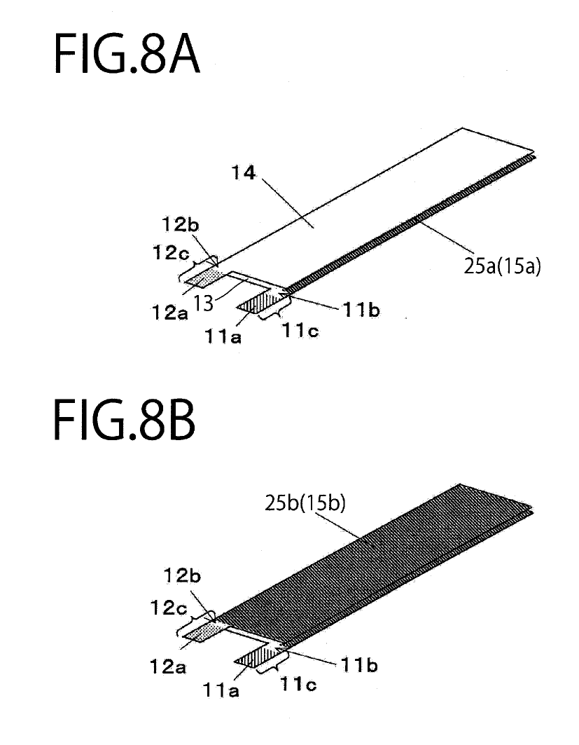

A method of manufacturing the capacitor of the third embodiment is described next. FIGS. 7A to 7C, and FIGS. 8A and 8B are perspective views for explanation of steps of manufacturing the capacitor of the third embodiment.

As shown in FIG. 7A, the long-length anode 11 in the form of a foil made of a valve acting metal and the long-length cathode 12 in the form of a foil made of a valve acting metal are prepared. The narrow part 11c is formed at an edge portion of the anode 11, and the narrow part 12c is formed at an edge portion of the cathode 12.

Next, the anode 11 except the front portion 11a of the narrow part 11c is dipped in an electrolyte solution, and a voltage is applied between the anode 11 and the electrolyte solution (chemical conversion). As a result, an oxide film of the metal forming the anode 11 is formed on the entire surface of part of the anode 11 dipped in the electrolyte solution, and the oxide film thereby formed becomes the first dielectric layer 13 as shown in FIG. 7B.

Thus, part of the first dielectric layer 13 is formed on the root portion 11b of the narrow part 11c, while the first dielectric layer 13 is not formed on the front portion 11a of the narrow part 11c.

Likewise, the cathode 12 except the front portion 12a of the narrow part 12c is dipped in an electrolyte solution, and a voltage is applied between the cathode 12 and the electrolyte solution (chemical conversion). As a result, an oxide film of the metal forming the cathode 12 is formed on the entire surface of part of the cathode 12 dipped in the electrolyte solution, and the oxide film thereby formed becomes the second dielectric layer 14 as shown in FIG. 7B. Thus, part of the second dielectric layer 14 is formed on the root portion 12b of the narrow part 12c, while the second dielectric layer 14 is not formed on the front portion 12a of the narrow part 12c.

Next, as shown in FIG. 7C, an adhesive agent 25a to form the adhesive layer 15a is applied on one side of the first dielectric layer 13. Examples of process for application of the adhesive agent 25a include, but not specifically limited to, spin-coating process, dipping process, drop casting process, ink jet process, spraying process, screen printing process, gravure printing process, flexographic process, and vapor deposition process.

Then, the anode 11 and the cathode 12 are stacked such that the first and second dielectric layers 13 and 14 face each other, and that the adhesive agent 25a is placed between the first and second dielectric layers 13 and 14 as shown in FIG. 8A. At this time, the anode 11 and the cathode 12 are arranged such that the narrow parts 11c and 12c point in the same direction, and that the narrow parts 11c and 12c are spaced apart from each other at the interval W. As a result, the adhesive layer 15a is formed between the first and second dielectric layers 13 and 14. So, the first and second dielectric layers 13 and 14 are made to adhesively contact each other through the adhesive layer 15a to complete the formation of the stacked structure.

Next, as shown in FIG. 8B, an adhesive agent 25b to become the adhesive layer 15b is applied to a surface region of the stacked structure in which the second dielectric layer 14 is exposed. Then, the stacked structure is wound into a spiral pattern to complete the formation of the capacitor element 101 shown in FIG. 6.

Finally, the capacitor element 101 is covered with a molten epoxy resin and thereafter, the epoxy resin is cured, thereby forming the outer package 18. At this time, the front portion 11a of the narrow part 11c is exposed to the outside of the outer package 18, and the front portion 12a of the narrow part 12c is exposed to the outside of the outer package 18. Then, formation of the capacitor of the third embodiment is completed.

The capacitor of the third embodiment has a structure where the anode 11 and the cathode 12 are wound into a spiral pattern, so requires only one anode 11 and only one cathode 12. This eliminates complicated process of stacking a large number of anodes 11 and a large number of cathodes 12, making it possible to simplify manufacturing steps.

Further, in the capacitor of the third embodiment, part of the anode 11 (the front portion 11a of the narrow part 11c) and part of the cathode 12 (the front portion 12a of the narrow part 12c) form an anode extraction electrode and a cathode extraction electrode respectively. So, extraction electrodes can be formed without the need of adding different members to the anode 11 and the cathode 12. As a result, the capacitor is allowed to have a simple structure and can be manufactured by simple manufacturing steps.

In order to evaluate the effects achieved by the embodiments described above, the inventors of the invention made prototypes of a capacitor composed of an anode 1 and a cathode 2, and evaluated the characteristics thereof, as is described in detail below.

### Example 1

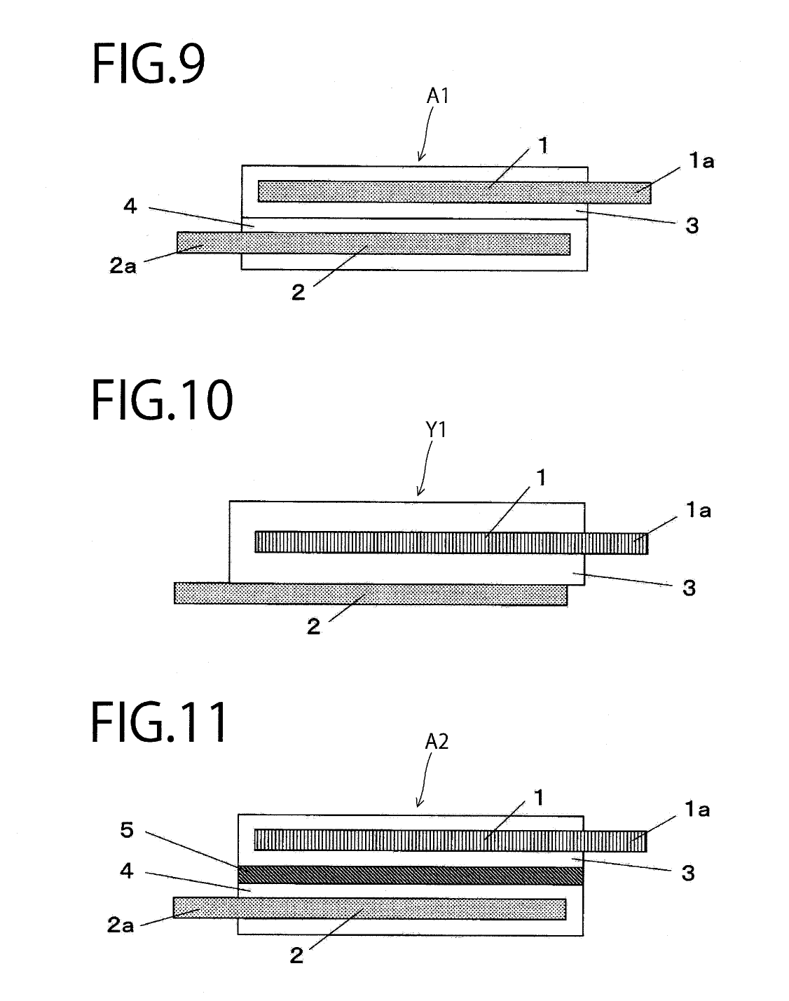

FIG. 9 shows a capacitor A1 of Example 1. The capacitor A1 is an example of the capacitor of the first embodiment.

In Example 1, hydration process was performed in pure water at a temperature of 95° C. on the anode 1 composed of an aluminum foil in the form of a rectangular parallelepiped measuring 3.0 cm by 2.5 cm and 30 μm in thickness. Next, the anode 1 except the edge portion 1a thereof was dipped in an electrolyte solution at a temperature of 95° C., and a constant voltage of 250 V was applied for 20 minutes between the anode 1 and the electrolyte solution (chemical conversion). A 10 percent aqueous solution of boron was used as the electrolyte solution.

Next, the anode 1 was cleaned for 10 minutes with flowing pure water, and thereafter, subjected to thermal process for two minutes at a temperature of 500° C. Further, the part of the anode 1 having been dipped in the electrolyte solution was dipped again in an electrolyte solution at a temperature of 95° C., and a constant voltage of 250 V was applied for five minutes between the anode 1 and the electrolyte solution (second chemical conversion). Then, the anode 1 was cleaned with flowing water for 10 minutes, and was dried in an atmosphere at a temperature of 100° C. As a result, the first dielectric layer 3 of a thickness of 375 nm was formed on a surface of the anode 1 except a surface of the edge portion 1a.

The chemical conversion process performed on the anode 1 was also performed on the cathode 2 composed of an aluminum foil of the same shape as that of the anode 1. As a result, the second dielectric layer 4 of a thickness of 375 nm was formed on a surface of the cathode 2 except a surface of the edge portion 2a.

Finally, as shown in FIG. 9, the anode 1 and the cathode 2 were stacked such that their edge portions 1a and 2a respectively were pulled out toward opposite directions, and that the first and second dielectric layers 3 and 4 face each other. As a result, the capacitor A1 shown in FIG. 9 was formed. In the capacitor A1, two dielectric layers (first and second dielectric layers 3 and 4) are placed between the anode 1 and the cathode 2.

Next, the withstand voltage and the electrostatic capacitance of the capacitor A1 were measured. The withstand voltage was measured by measuring current-voltage characteristics of the capacitor A1. More specifically, a voltage was applied between the edge portions 1a and 2a while terminals were connected to the edge portions 1a and 2b, and the applied voltage was increased stepwise. A current thereby caused to flow between the edge portions 1a and 2a was measured. If the value of the current was increased up to 20 mA, it was determined that the anode 1 and the cathode 2 were electrically shorted to each other. Then, the value of the voltage applied immediately before generation of the short was obtained as the withstand voltage. The electrostatic capacitance was measured with an LCR meter by connecting terminals to the edge portions 1a and 2a. The value of the electrostatic capacitance measured at a frequency of 120 Hz was obtained as the electrostatic capacitance of the capacitor A1.

### Comparative Example 1

FIG. 10 shows a capacitor Y1 of Comparative Example 1. The capacitor Y1 is an example of the conventional capacitor in which only one dielectric layer is placed between an anode and a cathode.

In Comparative Example 1, the anode 1 was formed in the same manner as in Example 1, except for that a constant voltage of 500 V was applied between the anode 1 and the electrolyte solution during chemical conversion process on the anode 1. As a result, the first dielectric layer 3 of a thickness of 750 nm was formed on a surface of the anode 1 except a surface of the edge portion 1a. Meanwhile, a dielectric layer was not formed on the cathode 2.

Next, the anode 1 and the cathode 2 were stacked such that the first dielectric layer 3 was placed between the anode 1 and the cathode 2. As a result, the capacitor Y1 shown in FIG. 10 was formed. The withstand voltage and the electrostatic capacitance of the capacitor Y1 were thereafter measured in the same manner as in Example 1.

Table 1 shows results of measurement of the withstand voltages and the electrostatic capacitances of the capacitors A1 and Y1. A withstand voltage ratio in Table 1 means the ratio of the withstand voltage of each capacitor with respect to the withstand voltage of the capacitor Y1 (Comparative Example 1). An electrostatic capacitance ratio in Table 1 means the ratio of the electrostatic capacitance of each capacitor with respect to the electrostatic capacitance of the capacitor Y1 (Comparative Example 1).

TABLE 1

| | VOLTAGE (V) FOR CHEMICAL | THICKNESS (nm) OF | VOLTAGE (V) FOR CHEMICAL |
|---|---|---|---|
| | CONVERSION OF ANODE | FIRST DIELECTRIC LAYER | CONVERSION OF CATHODE |
| CAPACITOR A1 | 250 | 375 | 250 |
| CAPACITOR Y1 | 500 | 750 | 0 |
| | THICKNESS (nm) OF | ELECTROSTATIC | WITHSTAND VOLTAGE |
| | SECOND DIELECTRIC LAYER | CAPACITANCE RATIO | RATIO |
| CAPACITOR A1 | 375 | 1.0 | 1.4 |
| CAPACITOR Y1 | 0 | 1.0 | 1.0 |

Referring to Table 1, comparison between the capacitor A1 (Example 1) and the capacitor Y1 (Comparative Example 1) shows that the capacitors A1 and Y1 achieved the same electrostatic capacitance. This is considered to result from the facts that a total thickness of the dielectric layers of the capacitor A1 and that of the dielectric layer of the capacitor Y1 are equally 750 nm, that distances between the anode 1 and the cathode 2 are the same in the capacitors A1 and Y1, that areas occupied by facing electrodes are the same in the capacitors A1 and Y1, and that an oxide forming the dielectric layers of the capacitor A1 is of the same type as that of an oxide forming the dielectric layer of the capacitor Y1.

Meanwhile, the withstand voltage of the capacitor A1 is 1.4 times greater than that of the capacitor Y1. To be specific, despite the fact that the total thickness of the dielectric layers of the capacitor A1 is the same as that of the dielectric layer of the capacitor Y1, the withstand voltage of the capacitor A1 was increased significantly. This is considered to result from the fact that, while only one dielectric layer is placed between the anode 1 and the cathode 2 in the capacitor Y1, two dielectric layers are placed therebetween in the capacitor A1. To be specific, in the capacitor A1, the cracks 9 in the dielectric layers are unlikely to link to each other between the anode 1 and the cathode 2, and this is considered to make the anode 1 and the cathode 2 unlikely to be electrically shorted to each other (see FIG. 3).

### Example 2

FIG. 11 shows a capacitor A2 of Example 2. The capacitor A2 is an example of the capacitor of the second embodiment.

In Example 2, the anode 1 and the cathode 2 were formed in the same manner as in Example 1. Then, the anode 1 and the cathode 2 were stacked in the same positions with respect to each other as those of Example 1. At this time, the first and second dielectric layers 3 and 4 were bonded together with the adhesive layer 5 made of a cyanoacrylate resin. As a result, the capacitor A2 shown in FIG. 11 was formed. The withstand voltage and the electrostatic capacitance of the capacitor A2 were thereafter measured in the same manner as in Example 1.

### Example 3

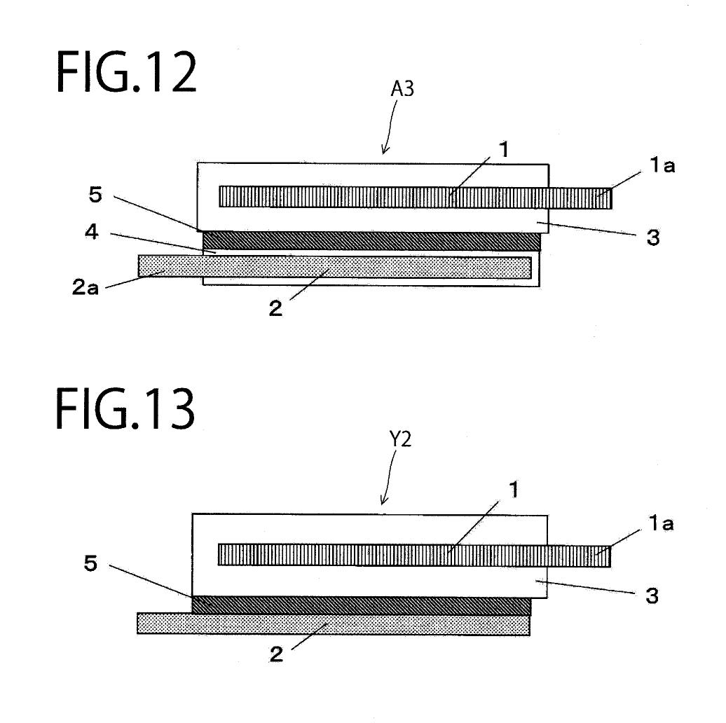

FIG. 12 shows a capacitor A3 of Example 3. The capacitor A3 is a different example of the capacitor of the second embodiment.

In Example 3, the anode 1 and the cathode 2 were formed in the same manner as in Example 1. Meanwhile, a constant voltage of 400 V was applied between the anode 1 and the electrolyte solution during chemical conversion process on the anode 1. As a result, the first dielectric layer 3 of a thickness of 600 nm was formed on a surface of the anode 1 except a surface of the edge portion 1a. Further, a constant voltage of 100 V was applied between the cathode 2 and the electrolyte solution during chemical conversion process on the cathode 2. As a result, the second dielectric layer 4 of a thickness of 150 nm was formed on a surface of the cathode 2 except a surface of the edge portion 2a.

Next, the anode 1 and the cathode 2 were stacked in the same positions with respect to each other as those of Example 1. At this time, the first and second dielectric layers 3 and 4 were bonded together with the adhesive layer 5 made of a cyanoacrylate resin. As a result, the capacitor A3 shown in FIG. 12 was formed. The withstand voltage and the electrostatic capacitance of the capacitor A3 were thereafter measured in the same manner as in Example 1. The capacitors A2 and A3 have different thicknesses of the first dielectric layer 3 and different thicknesses of the second dielectric layer 4, whereas they have the same total thickness of the dielectric layers of 750 nm.

### Comparative Example 2

FIG. 13 shows a capacitor Y2 of Comparative Example 2. The capacitor Y2 is a still different example of the capacitor of the second embodiment.

In Comparative Example 2, the anode 1 was formed in the same manner as in Example 1, except for that a constant voltage of 500 V was applied between the anode 1 and the electrolyte solution during chemical conversion process on the anode 1. As a result, the first dielectric layer 3 of a thickness of 750 nm was formed on a surface of the anode 1 except a surface of the edge portion 1a. Meanwhile, a dielectric layer was not formed on the cathode 2.

Next, the anode 1 and the cathode 2 were stacked such that the first dielectric layer 3 was placed between the anode 1 and the cathode 2. At this time, the first dielectric layer 3 and the cathode 2 were bonded together with the adhesive layer 5 made of a cyanoacrylate resin. As a result, the capacitor Y2 shown in FIG. 13 was formed. The withstand voltage and the electrostatic capacitance of the capacitor Y2 were thereafter measured in the same manner as in Example 1.

Table 2 shows results of measurement of the withstand voltages and the electrostatic capacitances of the capacitors A2, A3 and Y2. A withstand voltage ratio in Table 2 means the ratio of the withstand voltage of each capacitor with respect to the withstand voltage of the capacitor Y2 (Comparative Example 2). An electrostatic capacitance ratio in Table 2 means the ratio of the electrostatic capacitance of each capacitor with respect to the electrostatic capacitance of the capacitor Y2 (Comparative Example 2).

TABLE 2

| | VOLTAGE (V) FOR CHEMICAL | THICKNESS (nm) OF | VOLTAGE (V) FOR CHEMICAL |
|---|---|---|---|
| | CONVERSION OF ANODE | FIRST DIELECTRIC LAYER | CONVERSION OF CATHODE |
| CAPACITOR A2 | 250 | 375 | 250 |
| CAPACITOR A3 | 400 | 600 | 100 |
| CAPACITOR Y2 | 500 | 750 | 0 |
| | THICKNESS (nm) OF | ELECTROSTATIC | WITHSTAND VOLTAGE |
| | SECOND DIELECTRIC LAYER | CAPACITANCE RATIO | RATIO |
| CAPACITOR A2 | 375 | 1.1 | 1.3 |
| CAPACITOR A3 | 150 | 1.0 | 1.4 |
| CAPACITOR Y2 | 0 | 1.0 | 1.0 |

Referring to Table 2, comparison between the capacitors A2 and A3 (Examples 2 and 3), and the capacitor Y2 (Comparative Example 2) shows that the capacitors A2, A3 and Y2 achieved substantially the same electrostatic capacitance. This is considered to result from the facts that a total thickness of the dielectric layers of the capacitor A2, that of the dielectric layers of the capacitor A3, and that of the dielectric layer of the capacitor Y2 are equally 750 nm, that distances between the anode 1 and the cathode 2 are the same in the capacitors A2, A3 and Y2, that areas occupied by facing electrodes are the same in the capacitors A2, A3 and Y2, and that an oxide forming the dielectric layers of the capacitor A2 and an oxide forming the dielectric layers of the capacitor A3 are of the same type as that of an oxide forming the dielectric layer of the capacitor Y2.

Meanwhile, the withstand voltages of the capacitors A2 and A3 are 1.3 times and 1.4 times respectively greater than that of the capacitor Y2. To be specific, despite the fact that the total thickness of the dielectric layers of the capacitor A2 and that of the dielectric layers of the capacitor A3 are the same as that of the dielectric layer of the capacitor Y2, the withstand voltages of the capacitors A2 and A3 were increased significantly. This is considered to result from the fact that, while only one dielectric layer is placed between the anode 1 and the cathode 2 in the capacitor Y2, two dielectric layers are placed therebetween in the capacitors A2 and A3. To be specific, in the capacitors A2 and A3, the cracks 9 in the dielectric layers are unlikely to link to each other between the anode 1 and the cathode 2, and this is considered to make the anode 1 and the cathode 2 unlikely to be electrically shorted to each other (see FIG. 3).

Further, the capacitor A3 achieved a withstand voltage greater than that of the capacitor A2. This result was obtained despite the facts that the capacitors A2 and A3 have the same total thickness of the dielectric layers, and that the capacitors A2 and A3 both have a structure where two dielectric layers are placed between the anode 1 and the cathode 2. Meanwhile, the thickness of the second dielectric layer 4 is 375 nm in the capacitor A2, whereas it is 150 nm in the capacitor A3. So, reducing the thickness of one of the two dielectric layers is considered to reduce the number of cracks generated in the thinner dielectric layer. As a result, the cracks 9 in the dielectric layers are unlikely to link to each other between the anode 1 and the cathode 2, and this is considered to make the anode 1 and the cathode 2 unlikely to be electrically shorted to each other.

In the capacitor A3 (Example 3), the second dielectric layer 4 has a thickness (150 nm) 0.2 times the total thickness of the dielectric layers (750 nm). It is difficult for a dielectric layer to have a uniform thickness if the dielectric layer is too thin. So, it is preferable that a dielectric layer have a thickness of 10 nm or greater. To be specific, it is preferable that the thinner dielectric layer have a thickness of from 0.01 times to 0.5 times the total thickness of the dielectric layers.

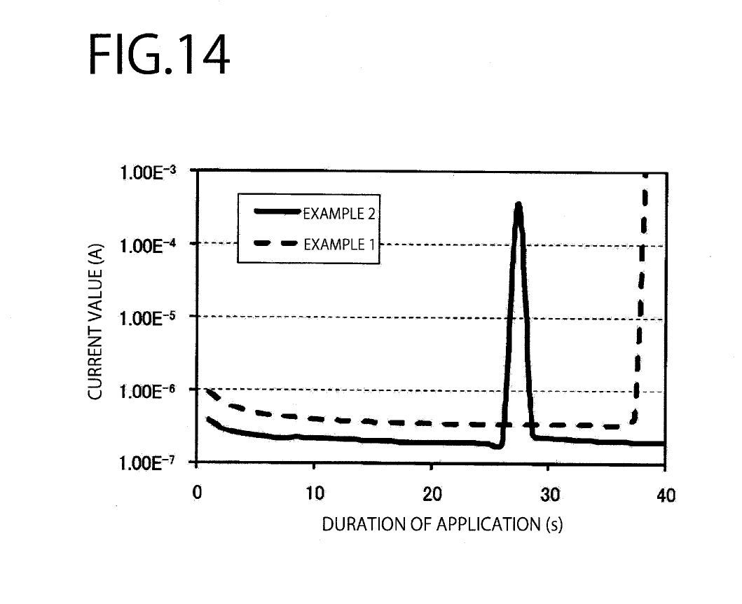

FIG. 14 shows changes of currents with time flowing between the electrodes of the capacitor of Example 1 and between the electrodes of the capacitor of Example 2 of the invention. Relationships between the values of currents (vertical axis) flowing between the anode 1 and the cathode 2 in response to application of voltages to the capacitors and duration of application of the voltages (horizontal axis) are graphed in FIG. 14. A voltage of 350 V was applied to the capacitor A1 of Example 1, and a voltage of 420 V was applied to the capacitor A2 of Example 2.

As shown in FIG. 14, in the capacitor A1 (Example 1), the current value increased steeply after elapse of certain time, and was kept high thereafter. This was caused by electrical short generated between the electrodes.

In contrast, in the capacitor A2 (Example 2), the current value increased once during application of the voltage, but decreased immediately after the increase to return to a level observed before the increase. This is considered to result from the fact that a current intensively flowing into a defect in a dielectric layer generated heat near the defect, and this heat made the adhesive layer 5 swell to increase a distance between the anode 1 and the cathode 2, or changed the properties of the adhesive layer 5 to enhance the electrical insulating properties of the adhesive layer 5. In either case, it is considered that electrical isolation between the electrodes was recovered. So, even if a high voltage of a level close to the withstand voltage of the capacitor is applied to the capacitor, the presence of the adhesive layer 5 is capable of preventing electrical short between the electrodes before it happens.

The structure of each part of the invention is not limited to that shown in the embodiments described above. Various modifications can be devised without departing from the technical scope recited in claims. In the embodiments described above, metal foils are used as the anode 1 and the cathode 2, to which the invention is not intended to be limited. Flat plate metals of various types different from metal foils may be used as the anode 1 and the cathode 2.

The polarities of the electrodes are not limited to those given in the embodiments described above. As an example, in the aforementioned embodiments, the anode 1 may be used as a cathode, and the cathode 2 may be used as an anode.

1. A capacitor, comprising:
an anode made of metal;
a first dielectric layer formed on a surface of the anode, the first dielectric layer containing an oxide of the metal forming the anode;
a cathode made of metal; and
a second dielectric layer formed on a surface of the cathode, the second dielectric layer containing an oxide of the metal forming the cathode,
the anode and the cathode being stacked such that the first and second dielectric layers face each other.

2. The capacitor according to claim 1, wherein an adhesive layer having electrical insulating properties is placed between the first and second dielectric layers.

3. The capacitor according to claim 1, wherein one of the first and second dielectric layers is smaller in thickness than the other of the first and second dielectric layers.

4. The capacitor according to claim 1, wherein the first dielectric layer is an oxide film formed by performing chemical conversion process on the anode, and the second dielectric layer is an oxide film formed by performing chemical conversion process on the cathode.

5. The capacitor according to claim 1, wherein the anode includes a plurality of anodes and the cathode includes a plurality of cathodes, and the anodes and the cathodes are stacked so as to overlap each other alternately.

6. The capacitor according to claim 1, wherein the anode and the cathode are stacked while the anode and the cathode are wound in a spiral pattern.
